(19) United States
(12) Patent Application Publication
(10) Pub. No.: US 2012/0313811 A1
(43) Pub. Date: Dec. 13, 2012

(54) OBSTACLE DETECTION APPARATUS

(75) Inventor: Koji Suzuki, Susono-shi (JP)

(73) Assignee: TOYOTA JIDOSHA KABUSHIKI KAISHA, Toyota-shi, Aichi (JP)

(21) Appl. No.: 13/575,835

(22) PCT Filed: Jan. 28, 2010
(86) PCT No.: PCT/JP2010/051114

§ 371 Date: Jul. 27, 2012

(51) Int. Cl. G01S 13/93

(52) U.S. Cl. 342/147

(57) ABSTRACT

It is determined with high accuracy whether a target is an obstacle. Provision is made for a plurality of receiving antennas, and determination unit to determine a target is not an obstacle, if a rate of change in a reception intensity of reflected waves is within a predetermined range. A determination of an obstacle is carried out by making use of the fact that the reception intensity varies upon occurrence of multipath.

### TECHNICAL FIELD

The present invention relates to an obstacle detection apparatus.

### BACKGROUND ART

There has been known a technique in which eight receiving antennas are arranged in a horizontal direction, with the first and the eighth receiving antenna being shifted in an upward direction from the other receiving antennas, wherein the azimuth in a vertical direction of a target is obtained from a first oblique direction formed by the first receiving antenna and the second receiving antenna, and from a second oblique direction formed by the seventh receiving antenna and the eighth receiving antenna (for example, refer to a first patent document).

In this technique, DBF (digital beam forming) processing is carried out on signals obtained by the first through eighth receiving antennas, so that a distance, a relative speed and a horizontal angle of the target are detected. After that, the azimuth of the target with respect to the first oblique direction and the azimuth of the target with respect to the second oblique direction are respectively detected by the use of a phase monopulse system, and the azimuth in the vertical direction of the target is obtained from two detection results.

However, it is not necessary for an iron plate (steel sheet) laid on a road or irregularities on a road surface or the like, over which a vehicle can pass through, to be regarded as an obstacle. Also, it is not necessary for a signboard arranged above a road or a bridge crossing over a road, under which a vehicle can pass, to be regarded as an obstacle. On the other hand, if these objects are determined to be obstacles, there will be a fear that an unnecessary warning or an unnecessary brake operation may be carried out. For that reason, it is desired to enhance the accuracy in the determination as to whether a target detected by a radar becomes an obstacle.

### PRIOR ART REFERENCES

### Patent Documents

[First Patent Document] Japanese patent application laid-open No. H11-287857

[Second Patent Document] Japanese patent application laid-open No. 2008-151583

### SUMMARY OF THE INVENTION

### Problems to be Solved by the Invention

The present invention has been made in view of the problem as referred to above, and has for its object to provide a technique in which a determination can be made with a high degree of accuracy as to whether a target is an obstacle.

### Means for Solving the Problems

In order to achieve the above-mentioned object, an obstacle detection apparatus according to the present invention adopts the following means.

That is, an obstacle detection apparatus according to the present invention is characterized by comprising:

a receiving antenna part having a plurality of receiving antennas; and

determination means to determine a target is not an obstacle, if a rate of change in a reception intensity of reflected waves from said target received by said receiving antennas is within a predetermined range.

Here, if the target is assumed to be a stationary object and a subject (own) vehicle approaches the target, the change over time of the reception intensity of the reflected waves is different between an object with a relatively high height such as a vehicle, etc., and an object with a relatively low height such as an iron plate, etc. That is, in the case of a target with a relatively high height such as a vehicle, etc., the target can be detected from a relatively long distance. And, the reception intensity becomes larger as the subject vehicle approaches this target. At this time, the reception intensity goes up while varying due to the influence of multipath exerted thereon. That is, when there is a shift or deviation in phase between the reflected waves which have passed through a path reflected on a road surface, and those which have passed through a linear path from the target without being reflected on the road surface, these reflected waves having passed through the different paths are cancelled with each other, resulting in a reduction in the reception intensity. On the other hand, when the phases of the respective reflected waves become the same, they are strengthened with each other so that the reception intensity goes up. That is, the reception intensity at the time when the subject vehicle is approaching a target such as another vehicle, etc., repeats rising and falling due to multipath, but an amount of rise becomes larger than an amount of fall, so that the reception intensity as a whole is going up.

On the other hand, those which are relatively low in height, such as an iron plate, irregularities on a road surface, or the like, each have a small plane of reflection, and hence can not be detected unless they come to within a relatively short distance. Then, these targets have almost no influence of multipath. That is, even if there is a path which reflects on a road surface, a phase difference of the reflected waves will hardly occur, so there will be almost no variation in the reception intensity due to multipath. For this reason, the reception intensity becomes larger as the subject vehicle approaches such a target, but the reception intensity hardly varies unlike the case in which the target is a vehicle or the like.

In addition, the receiving antennas are arranged in positions of certain heights from the road surface, and each have an angle range predecided in which they can detect targets. For this reason, even if what is low in height, such as an iron plate, exists immediately near the receiving antennas, it does not come into the detectable angle range, so it can not be detected. That is, when the subject vehicle approaches an object with a relatively low height, such as an iron plate, etc., to some extent, the reception intensity begins to fall, and thereafter, it will no longer be detected. In other words, the reception intensity at the time when the subject vehicle is approaching a target such as iron plate, etc., does not vary due to multipath, but as a whole, is first rising and then falling. This is the same even in the case of a target such as a signboard, a bridge, etc., which is arranged above a road.

In this manner, the change over time of the reception intensity is different according to the target, so when seeing the change over time of the reception intensity, it can be identified whether the target is one with a relatively low height, such as an iron plate, etc., or one with a relatively high height, such as a vehicle, etc. Here, an object with a low height such as an iron plate, etc., or a signboard, a bridge, etc., arranged above a road does not become an obstacle, because the subject vehicle can pass through it as it is.

Then, if the rate of change in the reception intensity of reflected waves from the target received by the receiving antennas is within a predetermined range, the determination means makes a determination that the target is not an obstacle. In this manner, it is possible to determine whether the target is an obstacle, without obtaining the height of the target. The predetermined range referred to herein can be set to a range in which the subject vehicle can pass through over the target. When the reception intensity varies, the rate of change thereof exhibits positive values and negative values in an alternate manner. Accordingly, the predetermined range includes negative values and positive values.

Here, note that the rate of change can be an amount of change per unit time, or a derivative or differential value, but instead of this, a determination may be made by the use of an amount of change within a prescribed period of time. In addition, when seeing the rate of change in the reception intensity, one of the following may be seen; the rate of change in a prescribed period of time, the rate of change when the reception intensity is within a prescribed range, and the rate of change when the distance of the target is within a prescribed range. Thus, by specifying or prescribing the time to see the rate of change, a determination can be made at the time when the accuracy of the determination becomes high, for example. Also, it becomes possible to make a prompt determination. For example, a vehicle or the like can be detected by means of a radar from a relatively long distance, but the influence of multipath is small in the case of a long distance, so the fluctuation or variation of the reception intensity is also small. Even if a determination as to whether a target is an obstacle is made based on the rate of change in the reception intensity at such a time, the accuracy in the determination becomes low, and hence, the determination may not be carried out at that time.

In addition, in the present invention, said receiving antenna part has a plurality of combinations of the receiving antennas, of which the directions of arrangement are different from one another, and

said determination means can detect the target a plurality of times while changing the combination of said receiving antennas, make a determination that said target is not an obstacle, if the rate of change in the reception intensity in each combination is within said predetermined range, and make a determination that said target is an obstacle, if the rate of change in the reception intensity in at least one of the combinations is out of said predetermined range.

If there are a plurality of combinations of the receiving antennas, it is possible to enhance the accuracy in the determination by making a comparison between the rate of change in the reception intensity and the predetermined range in each combination.

In the present invention, said determination means can detect the target by means of a combination of receiving antennas arranged in a horizontal direction, and a combination of receiving antennas arranged in an oblique direction or a vertical direction.

By the use of these combinations, it is possible to detect an azimuth in the horizontal direction or a lateral position of the target, and an azimuth in the vertical direction or a height of the target, in combination. Here, note that there may be a plurality of combinations of receiving antennas arranged in the horizontal direction, and a plurality of combinations of receiving antennas arranged in oblique directions or the vertical direction. When a plurality of rates of change in the reception intensity are obtained by means of these combinations and used for determination, it will be possible to further enhance the accuracy of the determination.

Moreover, an obstacle detection apparatus according to the present invention is characterized by comprising:

a receiving antenna part that has a combination of receiving antennas arranged in a horizontal direction, and a combination of receiving antennas arranged in an oblique direction or a vertical direction;

detection means that detects a lateral position in the horizontal direction of a target and a height of said target by means of the combinations of said receiving antennas; and

determination means that determines, from the rate of change in the height of the target obtained by said detection means, whether said target is an obstacle.

Here, by the use of the combination of receiving antennas arranged in the horizontal direction, and the combination of receiving antennas arranged in the oblique direction or the vertical direction, it is possible to detect the azimuth in the horizontal direction and the azimuth in the vertical direction of the target. Also, the lateral position and the height of the target can be detected. Here, note that a determination as to whether the target is an obstacle can also be made based on the rate of change in the vertical direction.

Then, as described above, upon occurrence of multipath, the reception intensity varies, and so, the height of the target obtained from the reception intensity also varies. Accordingly, from the rate of change in the height of the target, too, it can be similarly determined whether the target is an obstacle.

In the present invention, if the rate of change in the height of said target is within a predetermined range, said determination means can make a determination that said target is not an obstacle.

The predetermined range referred to herein can be set to a range in which the subject vehicle can pass through over the target. Here, note that the rate of change can be an amount of change per unit time, or a derivative or differential value, but instead of this, a determination may be made by the use of an amount of change within a prescribed period of time. In addition, when seeing the rate of change in the height, one of the following may be seen; the rate of change in a prescribed period of time, and the rate of change when the distance of the target is within a prescribed range. Thus, by specifying or prescribing the time to see the rate of change, a determination can be made at the time when the accuracy of the determination becomes high, for example. Also, it becomes possible to make a prompt determination.

In the present invention, if a period of time in which the height of said target is equal to or larger than a predetermined height has continued for a predetermined period of time or more, said determination means can make a determination that said target is not an obstacle.

The predetermined height referred to herein is a lower limit value of a height at which the subject vehicle can pass through under the target. In addition, the predetermined period of time is a period of time taken to determine whether the target is an obstacle. Here, note that the predetermined period of time may be made as short as possible, while maintaining the accuracy of the determination. That is, if the detected height of the target is high to a sufficient extent and in addition, the time of duration or continuation is long to a sufficient extent, there will be a high possibility that the subject vehicle can pass through under the target, so a determination is made that the target is not an obstacle.

In the present invention, if the number of inflections of the rate of change in the height of said target is equal to or smaller than a predetermined value, said determination means can make a determination that said target is not an obstacle.

That is, if the height of the target varies, the rate of change thereof change alternately between positive values and negative values in a repeated manner. In the case of a target with a low height such as an iron plate or the like, there will be almost no variation in the height of the target, and so, the number of inflections will be small. Here, note that the predetermined value referred to herein can be set to an upper limit value of the number of inflections in which the subject vehicle can pass through over the target. This may be the number of inflections within a predetermined period of time. This predetermined period of time is a period of time taken to determine whether the target is an obstacle.

In the present invention, if a difference between a maximum value and a minimum value of the height of said target within a predetermined period of time is within a predetermined value, said determination means can make a determination that said target is not an obstacle.

If the height of the target varies, the difference between the maximum value and the minimum value of the height of the target becomes larger when it is limited by the predetermined period of time. The larger the extent or magnitude of the variation in the height of the target, the more remarkably this appears. The predetermined value referred to herein can be set to an upper limit value of the difference in which the subject vehicle can pass through over the target. The predetermined period of time can be set to a period of time taken to detect such a difference. For example, in accordance with the distance of the target, the reception intensity varies, and so, the detected height of the target also varies. As a result, the predetermined period of time may be set as a period of time in which the subject vehicle moves a distance in which the maximum value and the minimum value appear.

In the present invention, if the height of said target has exhibited negative values, which indicate that the height of said target is lower than a road surface, for a predetermined period of time or more, said determination means can make a determination that said target is not an obstacle.

Here, in the case of a signboard, a bridge or the like, which is located above a road, when the height thereof is obtained according to a monopulse system, it may be detected as if it is located below the road surface. By making use of this, it is determined whether a target exists above the road. Then, even if a target exists above the road, the subject vehicle can pass through under it, and hence a determination is made that the target is not an obstacle. The predetermined period of time is a period of time taken to determine whether the target is an obstacle.

### Effect of the Invention

According to the present invention, a determination can be made with a high degree of accuracy as to whether a target is an obstacle.

### BRIEF DESCRIPTION OF THE DRAWINGS

FIG. 1 is a schematic construction view of an obstacle detection apparatus according to an embodiment of the present invention.

FIG. 2 is a view showing an arrangement of receiving antennas according to the embodiment of the present invention.

FIG. 3 is a view showing another arrangement of receiving antennas according to the embodiment of the present invention.

FIG. 4 is a flow chart showing an obstacle determination flow according to a first embodiment of the present invention.

FIG. 5 is a flow chart showing an obstacle determination flow according to a second embodiment of the present invention.

FIG. 6 is a flow chart showing the obstacle determination flow according to the second embodiment of the present invention.

FIG. 7 is a flow chart showing an obstacle determination flow according to a third embodiment of the present invention.

### MODES FOR CARRYING OUT THE INVENTION

Hereinafter, reference will be made to specific embodiments of an obstacle detection apparatus according to the present invention based on the attached drawings.

### First Embodiment

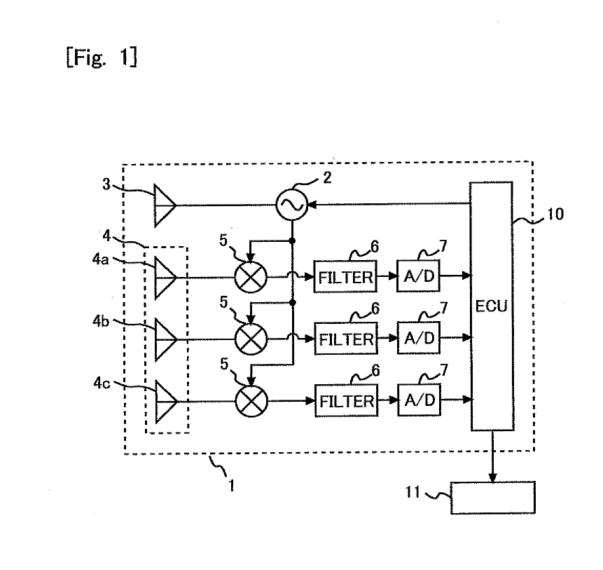

FIG. 1 is a schematic construction view of an obstacle detection apparatus 1 according to this first embodiment of the present invention. This obstacle detection apparatus 1 is mounted on a front portion of a vehicle, and serves to detect that a target exists ahead of the own vehicle, and to further detect a distance to the target, a relative speed and an azimuth of the target, etc. Millimeter waves are used as transmission radio waves. The obstacle detection apparatus 1 is constructed to include an oscillator 2, a transmitting antenna 3, a receiving antenna part 4, mixers 5, filters 6, ND converters 7, and an ECU 10.

The oscillator 2 oscillates at frequencies in a millimeter wave band with its center frequency of F0 (e.g., 76.5 GHz), and outputs a signal which has been subjected to frequency modulation in such a manner that its frequency changes in the shape of a triangular wave. The transmitting antenna 3 transmits radar waves in accordance with the transmission signal from the oscillator 2.

The receiving antenna part 4 receives reflected waves which are a part of the radar waves transmitted from the transmitting antenna 3 and reflected by an object. The receiving antenna part 4 is an array antenna, and is composed of a first receiving antenna 4a, a second receiving antenna 4b, and a third receiving antenna 4c. Then, the individual receiving antennas 4a, 4b, 4c are each constructed by a plurality of patch antennas which are arranged in an up and down (vertical) direction. The arrangement of the receiving antennas 4a, 4b, 4c will be described later. Here, note that in this embodiment, the first receiving antenna 4a, the second receiving antenna 4b, and the third receiving antenna 4c correspond to receiving antennas in the present invention. Also, note that there should just be three or more receiving antennas.

The mixers 5 are provided for the individual receiving antennas 4a, 4b, 4c, respectively, and local signals from the oscillator 2 are inputted to the individual mixers 5, respectively. Reception signals from the individual receiving antennas 4a, 4b, 4c are mixed with these local signals, respectively, so that they are down converted into intermediate frequencies. Beat signals (difference signals of the transmission signals and the reception signals, respectively) are obtained by the down conversion.

The filters 6 are provided for the individual receiving antennas 4a, 4b, 4c, respectively, so that they remove unnecessary signal components from the outputs of the individual mixers 5, respectively. The AID converters 7 are also provided for the individual receiving antennas 4a, 4b, 4c, respectively, so that they generate reception data by sampling the outputs of the individual filters 6, respectively.

An ECU 10 is constructed to include a CPU which executes programs, a ROM in which the programs to be executed by the CPU and data tables are stored, a RAM which is used as a working area, an input and output interface, and so on. For example, the ECU 10 activates the oscillator 2 so that it carries out processing to calculate the position and the relative speed of the target based on individual reception data which are obtained during the operation of the oscillator 2. Moreover, the ECU 10 controls a warning device 11 based on individual pieces of information on the azimuth, distance and relative speed of the target detected. The warning device 11 is a device which serves to warn the existence of an obstacle to the driver of the vehicle by the use of sound or light. Here, note that a seat belt pretensioner, an air bag, a brake, a throttle valve, or the like may be driven in accordance with the azimuth, distance and relative speed of the target.

Here, a triangular wave modulation FM-CW method will be described. When the beat frequency at the time when the relative speed is zero is FR, the Doppler frequency based on the relative speed is FD, the beat frequency in a zone in which the frequency increases (up zone) is FB1, and the beat frequency in a zone in which the frequency decreases (down zone) is FB2, the following relations hold.

FB1=FR−FD

FB2=FR+FD

Accordingly, by separately measuring the beat frequencies FB1 and FB2 in the up zone and the down zone of a modulation cycle, FR and FD can be obtained from the following equations.

FR=(FB1+FB2)/2

FD=(FB2−FB1)/2

Then, when FR and FD are found, the distance R and the speed V of the target can be obtained by the following equations.

R=(C/(4×ΔF×FM))×FR

V=(C/(2×F0))×FD

where C is the speed of light; FM is an FM modulation frequency; ΔF is a modulation width; and F0 is the center frequency.

Then, the azimuth of the target can be calculated according to the phase monopulse system. Here, referring, as an example, to the case where reflected waves are detected which are incident to two receiving antennas at an angle θ from their front surfaces, an azimuth angle θ of the target is calculated based on the following equation from a phase difference φ of the reflected waves received by both of the receiving antennas.

θ=sin⁻¹(λφ/2πD)

where D is the interval of both the receiving antennas, and λ is the wave length of the transmission pulses.

However, when the interval D of both the receiving antennas is set as a value longer than λ/2, a return of phase occurs, and the azimuth angle θ of the target becomes any of a plurality of candidates which are represented by the following equation, and hence, is not decided uniquely.

θ=sin⁻¹{λ(φ+2πK)/2πD}(K=0,1,2, . . . )

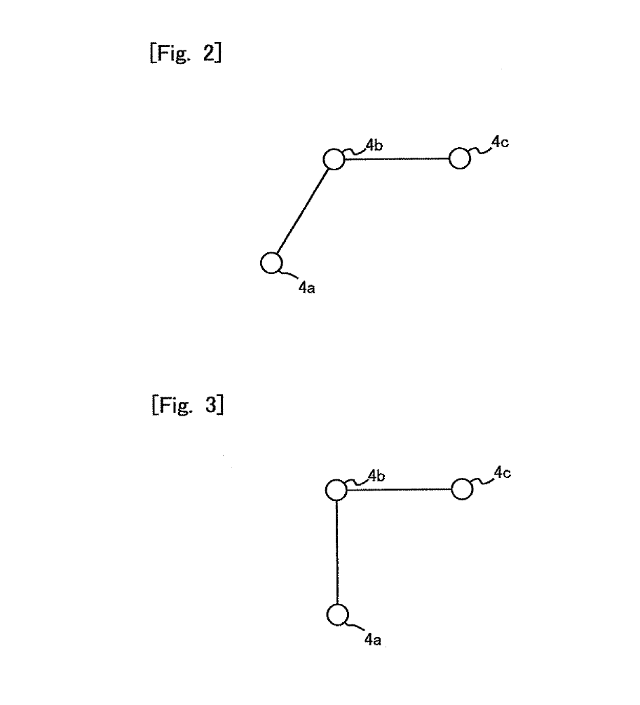

Here, FIG. 2 is a view showing the arrangement of the receiving antennas according to this first embodiment of the present invention. The first receiving antenna 4a, the second receiving antenna 4b, and the third receiving antenna 4c are arranged on the same plane. Here, note that FIG. 2 shows the center points of the individual receiving antennas 4a, 4b, 4c, respectively. In addition, FIG. 2 is a view when the receiving antenna part 4 is seen from the front of the vehicle.

In FIG. 2, the third receiving antenna 4c is arranged in the horizontal direction of the second receiving antenna 4b. In addition, the second receiving antenna 4b and the third receiving antenna 4c are arranged obliquely upward of the first receiving antenna 4a.

Here, note that in this embodiment, the azimuth of the target with respect to the horizontal direction is obtained by means of a monopulse system combining the second receiving antenna 4b and the third receiving antenna 4c. In addition, the azimuth of the target with respect to an oblique direction is obtained by means of a monopulse system combining the first receiving antenna 4a and the second receiving antenna 4b. Here, note that the azimuth of the target with respect to an oblique direction may instead be obtained by means of a monopulse system combining the first receiving antenna 4a and the third receiving antenna 4c.

Here, note that the receiving antennas 4a, 4b, 4c may be arranged in such a manner as shown in FIG. 3. FIG. 3 is a view showing another arrangement of receiving antennas according to this first embodiment of the present invention. In the arrangement shown in FIG. 3, the third receiving antenna 4c is arranged in the horizontal direction of the second receiving antenna 4b. In addition, the second receiving antenna 4b is arranged right above the first receiving antenna 4a, and the third receiving antenna 4c is arranged obliquely upward of the first receiving antenna 4a. In this case, the azimuth of the target with respect to the horizontal direction is obtained by means of a monopulse system combining the second receiving antenna 4b and the third receiving antenna 4c. Also, the azimuth of the target with respect to the up and down direction (the vertical direction) is obtained by means of a monopulse system combining the first receiving antenna 4a and the second receiving antenna 4b. Here, note that the following description will be given according to the arrangement shown in FIG. 2.

However, even in the case of a target detected by the receiving antenna part 4, it may also not correspond to an obstacle. For example, it is not necessary for an iron plate laid on a road or irregularities on a road surface or the like, over which a vehicle can pass through, to be regarded as an obstacle. Also, it is not necessary for a guide board, a signboard, a traffic light, a bridge, and so on arranged above a road, under which a vehicle can pass, to be regarded as obstacles. If these things which need not be regarded as obstacles are detected as obstacles, a warning unnecessary for a driver will be made.

Accordingly, in this embodiment, it is determined, based on the reception intensity of the reflected waves obtained by the receiving antennas 4a, 4b, 4c, whether the target is an obstacle. Here, if the target is assumed to be a stationary object and the subject vehicle approaches the target, the reception intensity of the reflected waves is different between an object with a relatively high height such as a vehicle, etc., and an object having a relatively low height such as an iron plate, etc. And, in general, the reception intensity becomes larger as the subject vehicle approaches the target. At this time, the reception intensity goes up while varying, if affected by the influence of multipath. That is, the reception intensity varies in accordance with a shift in phase between the reflected waves which have passed through a path reflected on a road surface, and those which have passed through a linear path from the target without being reflected on the road surface.

On the other hand, for those which have a relatively low height, such as an iron plate, etc., there will be almost no influence of multipath. That is, even if there is a path which reflects on a road surface, a phase difference of the reflected waves will hardly occur, so there will be almost no variation in the reception intensity due to multipath. For this reason, the reception intensity becomes larger as the subject vehicle approaches the target, but the reception intensity hardly varies unlike the case in which the target is a vehicle or the like.

In this manner, the change over time of the reception intensity varies according to the target, so when seeing the change over time of the reception intensity, it can be identified whether the target is one with a relatively low height, such as an iron plate, etc., or one with a relatively high height, such as a vehicle, etc. That is, a determination can be made as to whether the target is an obstacle.

Accordingly, in this embodiment, if the rate of change in the reception intensity of reflected waves from the target received by the receiving antennas 4a, 4b, 4c is in a predetermined range, there occurs no multipath for the target, and a determination is made that the target is not an obstacle. Here, note that the predetermined range can be set to a range in which the vehicle can pass through over the target.

Here, when combining two of the three receiving antennas 4a, 4b, 4c and obtaining the rate of change in the reception intensity by that combination, a determination can be made whether the target is an obstacle, but in this embodiment, in order to enhance the accuracy of the determination, the determination is carried out by the use of a combination of the first receiving antenna 4a and the second receiving antenna 4b, as well as a combination of the second receiving antenna 4b and the third receiving antenna 4c.

First, it is determined whether the rate of change in the reception intensity of the second receiving antenna 4b and the third receiving antenna 4c which are arranged in the horizontal direction is within the predetermined range. Here, according to the two receiving antennas 4b, 4c arranged in the horizontal direction, the azimuth in the horizontal direction of a target can be detected. Then, when the rate of change in the reception intensity is within the predetermined range, a determination is made that there exists a single object or that there has occurred no multipath. On the other hand, when the rate of change in the reception intensity is out of the predetermined range, a determination is made that there exist a plurality of targets, or that there has occurred a multipath, for example. Here, note that the plurality of the targets referred to herein are those targets which respectively have the same distance and the same relative speed. Then, a determination can be made that a target for which multipath has occurred is a target with a certain amount of height, such as a vehicle or the like, and hence, a determination is made that the target is an obstacle.

Subsequently, it is determined whether the rate of change in the receiving intensity of the first receiving antenna 4a and the second receiving antenna 4b which are arranged in an oblique direction is within the predetermined range. Here, according to the two receiving antennas 4a, 4b arranged in the oblique direction, the azimuth in the oblique direction of a target can be detected. Then, when the rate of change in the reception intensity is within the predetermined range, there has occurred no multipath, and a determination is made that the target detected is not an obstacle. On the other hand, when the rate of change in the reception intensity is out of the predetermined range, a determination is made that the target detected is an obstacle. The obstacle referred to herein is, for example, a single target, or a bridge which is arranged above a road and an obstacle which is arranged under the bridge. Here, note that the sequence of comparison of the rate of change in the reception intensity may be reversed between the horizontal direction and the oblique direction.

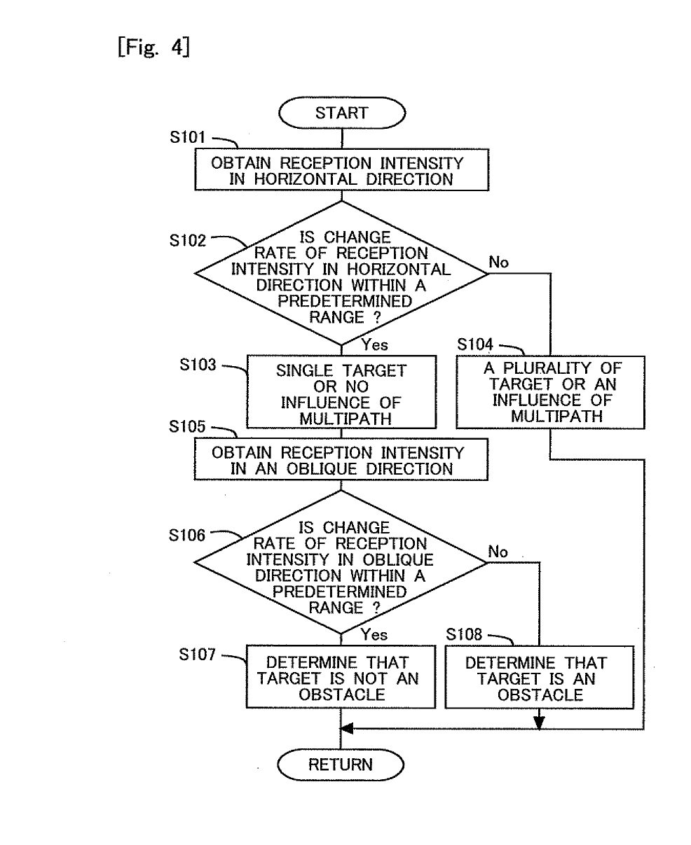

FIG. 4 is a flow chart showing an obstacle determination flow or routine according to this first embodiment of the present invention. This routine is carried out by means of the ECU 10 in a repeated manner.

In step S101, the reception intensity of each of the second receiving antenna 4b and the third receiving antenna 4c, which are arranged in the horizontal direction, is obtained.

In step S102, it is determined whether the rate of change in the reception intensity obtained in step S101 is within the predetermined range. In this step, it is determined whether multipath has occurred.

If an affirmative determination is made in step S102, the routine advances to step S103, in which a determination is made that there is a single target or there is a target with no influence of multipath. On the other hand, if a negative determination is made in step S102, the routine advances to step S104, in which a determination is made that there are a plurality of targets or there is a target with an influence of multipath. In addition, in step S104, a determination may also be made that the target is an obstacle.

In step S105, the reception intensity of each of the first receiving antenna 4a and the second receiving antenna 4b arranged in an oblique direction is obtained.

In step S106, it is determined whether the rate of change in the reception intensity obtained in step S105 is within the predetermined range. In this step, it is determined whether multipath has occurred.

If an affirmative determination is made in step S106, the routine advances to step S107, in which a determination is made that the target is not an obstacle. On the other hand, if a negative determination is made in step S106, the routine advances to step S108, in which a determination is made that the target is an obstacle.

Then, if a determination is made according to this routine that the target is an obstacle, the warning device 11 is operated. On the other hand, if the target is not an obstacle, the warning device 11 is not operated. Here, note that in this embodiment, the ECU 10, which carries out the processing of step S102 or step S106, corresponds to determination means in the present invention.

As described above, according to this embodiment, by determining, according to the state of variation in the reception intensity of the reflected waves, whether there is an influence of multipath, it is possible to determine whether the target is an obstacle. As a result of this, an iron plate (steel sheet) or the like is not determined to be an obstacle, so it is possible to suppress an unnecessary warning from being made.

Here, note that in this embodiment, a determination as to whether the target is an obstacle is made based on the rate of change in the reception intensity, but instead of this, such a determination may be made by the use of an amount of change within a prescribed period of time. For example, the larger the influence of multipath, the larger becomes the amount of change within the prescribed period of time, so when this amount of change is within a predetermined range, a determination may be made that the target is not an obstacle.

In addition, when the rate of change in the reception intensity is seen, the rate of change within the prescribed period of time may be seen. That is, a determination may be carried out by setting a limit on the time. Thus, by specifying the time to see the rate of change, a determination can be made at the time when the accuracy of the determination becomes high, for example. Also, it becomes possible to make a prompt determination. Further, if a target is at a long distance, even if it is an obstacle, the rate of change in the reception intensity will be small, and hence, a determination may be made after the target has approached to a distance at which the influence of multipath becomes large.

Moreover, more receiving antennas may be arranged in the horizontal direction and in oblique directions, so that the detection accuracy of a target can be enhanced. Then, by using more combinations of the receiving antennas, a determination as to whether the target is an obstacle may be made based on each of the reception intensities.

### Second Embodiment

In this second embodiment, processing of determining whether a target is an obstacle is different from that in the first embodiment. The other devices, parts and so on are the same as those in the first embodiment, so the explanation thereof is omitted. In this embodiment, it is determined, based on the height of a target obtained by the receiving antenna part 4, whether a target is an obstacle. Here, note that in this embodiment, a target to be detected is assumed to be a stationary object.

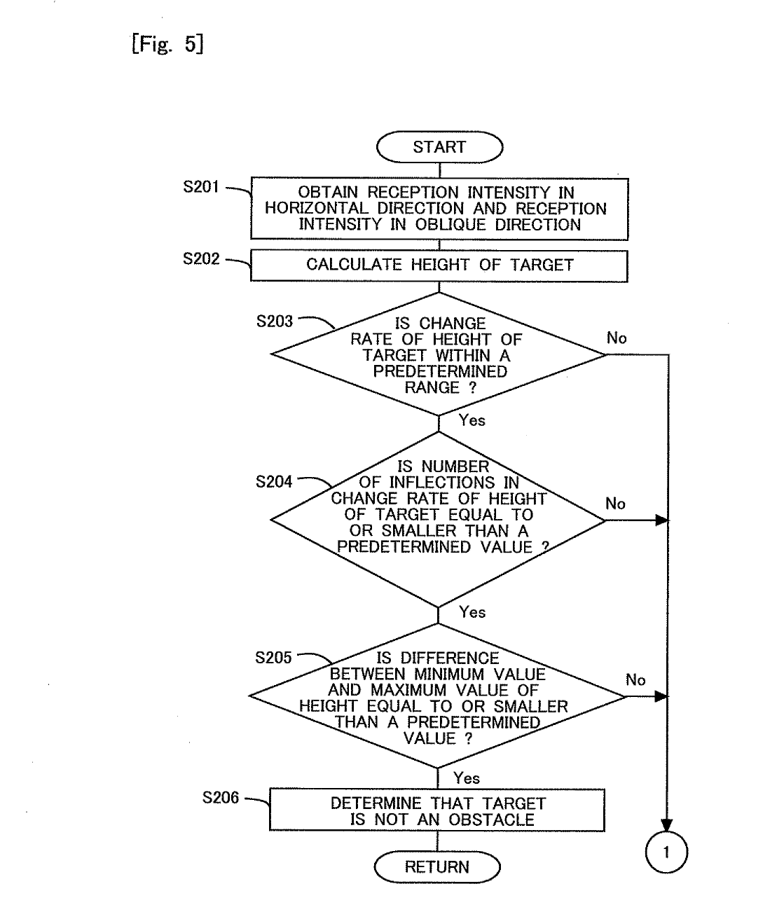

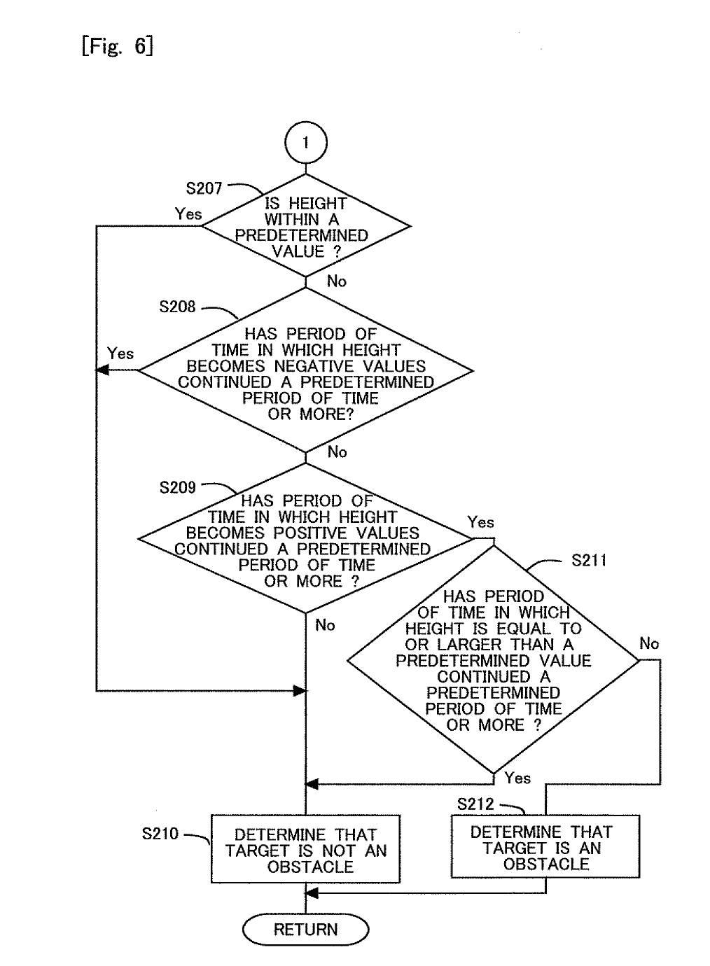

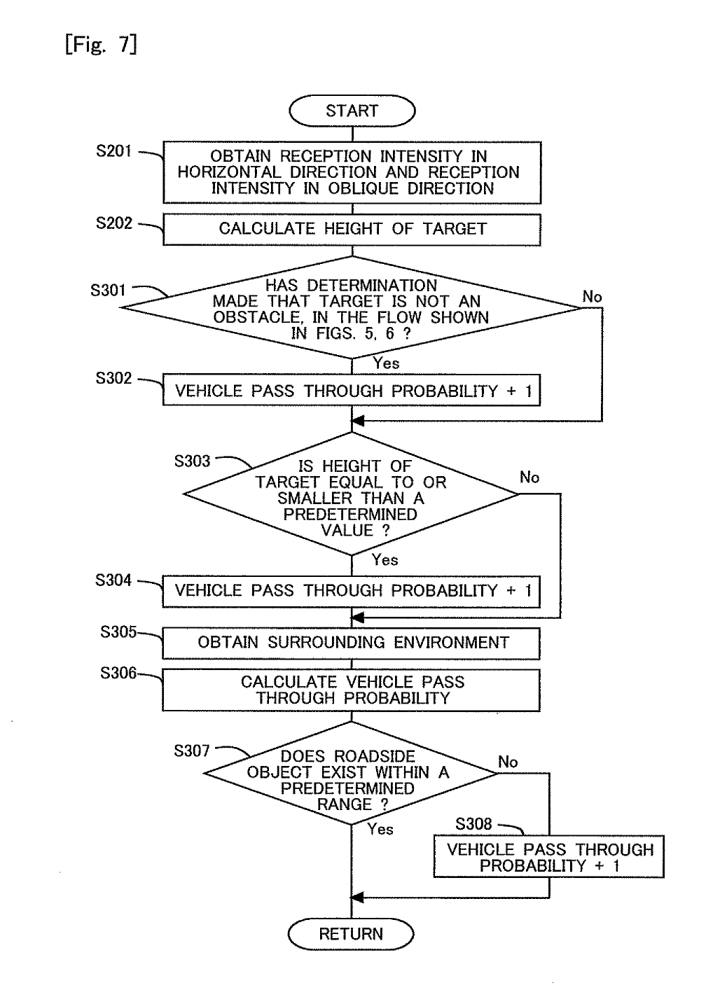

FIG. 5 and FIG. 6 are flow charts showing an obstacle determination flow or routine according to this second embodiment of the present invention. This routine is carried out by means of the ECU 10 in a repeated manner.

In step S201, the reception intensity of each of the second receiving antenna 4b and the third receiving antenna 4c, which are arranged in the horizontal direction, and the reception intensity of each of the first receiving antenna 4a and the second receiving antenna 4b, which are arranged in an oblique direction, are obtained, respectively.

In step S202, the height of a target is calculated. The height of the target is calculated by an azimuth in the horizontal direction, an azimuth in the oblique direction, and a distance of the target. This height of the target includes variation due to the occurrence of multipath. Here, note that in this second embodiment, the ECU 10, which carries out the processing of step S202, corresponds to detection means in the present invention.

In step S203, it is determined whether the rate of change in the height of the target is within a predetermined range. That is, for a target with a low height, such as an iron plate, there is almost no influence of multipath, and hence, the rate of change in the height of the target becomes within the predetermined range. Accordingly, if the rate of change in the height of the target is within the predetermined range, there will be a high possibility that the target is not an obstacle. Here, note that the predetermined range has been obtained in advance through experiments, etc., as a range of the rate of change in which the subject vehicle can pass through over the target. If an affirmative determination is made in step S203, the routine advances to step S204, whereas if a negative determination is made, the routine advances to step S207. Here, note that in this second embodiment, the ECU 10, which carries out the processing of step S203, corresponds to determination means in the present invention.

In step S204, it is determined whether the number of inflections of the rate of change in the height of the target within a predetermined period of time is equal to or less than a predetermined value. Here, if the height of the target varies, the rate of change thereof changes alternately between positive values and negative values in a repeated manner. In the case of a target with a low height such as an iron plate or the like, there will be no inflection, or the number of inflections will be small. Accordingly, when the number of inflections of the rate of change in the height of the target within a predetermined period of time is equal to or less than a predetermined value, there will be a high possibility that the target is not an obstacle. That is, the predetermined value can be set to an upper limit value of the number of inflections in the height of the target over which the subject vehicle can pass through. In addition, the predetermined period of time is a time taken to determine whether the target is an obstacle. Here, note that the predetermined period of time and the predetermined value have been obtained in advance through experiments, etc. If an affirmative determination is made in step S204, the routine advances to step S205, whereas if a negative determination is made, the routine advances to step S207.

In step S205, it is determined whether a difference between a maximum value and a minimum value the height of the target within a predetermined period of time is equal to or less than a predetermined value. Here, if the height of the target varies, the difference between the maximum value and the minimum value of the height of the target within the predetermined period of time becomes larger. Accordingly, when the difference between the maximum value and the minimum value of the height of the target within the predetermined period of time is equal to or less than the predetermined value, there will be a high possibility that the target is not an obstacle. The predetermined value referred to herein can be set to an upper limit value of the difference between the maximum value and the minimum value of the height of the target over which the subject vehicle can pass through. The predetermined period of time can be set to a period of time required to detect such a difference. The predetermined period of time and the predetermined value have been obtained in advance through experiments, etc. If an affirmative determination is made in step S205, the routine advances to step S206, whereas if a negative determination is made, the routine advances to step S207.

In step S206, a determination is made that the target is not an obstacle. In this embodiment, in order to enhance the accuracy of the determination as to whether the target is an obstacle, when an affirmative determination is made in all of the steps S203, 204 and 205, a determination is made that the target is not an obstacle. Here, note that if an affirmative determination is made once or more in these steps, a determination may be made that the target is not an obstacle.

Subsequently, in step S207, it is determined whether the height of the target is within a predetermined value. The predetermined value referred to herein can be set to an upper limit value of the height of the target over which the subject vehicle can pass through. If an affirmative determination is made in step S207, the routine advances to step S210, in which a determination is made that the target is not an obstacle. If a negative determination is made in step S207, the routine advances to step S208.

In step S208, it is determined whether a period of time in which the height of the target becomes negative values has continued for a predetermined period of time or more. For example, if the height of a bridge existing above a road is detected according to a monopulse system, the height of the bridge may be detected as a negative value due to phase return. If such a phenomenon continues for the predetermined period of time or more, it will be considered that the target is an object, such as a bridge or the like, located at a high place, and is an object under which the subject vehicle can pass through. Here, note that the predetermined period of time has been obtained as a period of time required for determination in advance through experiments, etc. If an affirmative determination is made in step S208, the routine advances to step S210, in which a determination is made that the target is not an obstacle. If a negative determination is made in step S208, the routine advances to step S209.

In step S209, it is determined whether a period of time in which the height of the target becomes positive values has continued for a predetermined period of time or more. Here, even if a negative determination is made in step S208, when the period of time in which the height of the target becomes positive values is short, there will be a high possibility that the target is not an obstacle. Accordingly, a determination is made that such a target is not an obstacle. The predetermined period of time referred to herein is a short period of time as compared with the predetermined period of time in step S208, and is a period of time taken to determine whether the target is an obstacle. If an affirmative determination is made in step S209, the routine advances to step S211, whereas if a negative determination is made, the routine advances to step S210, in which a determination is made that the target is not an obstacle.

In step S211, it is determined whether a period of time in which the height of the target becomes equal to or larger than a predetermined value has continued for a predetermined period of time or more. In this step, it is determined whether the height of the target is so high that the subject vehicle can pass through the target. The predetermined value referred to herein can be set to a lower limit value of the height of the target under which the subject vehicle can pass through. In addition, the predetermined period of time is a period of time taken to determine whether the target is an obstacle. The predetermined value is set as a value which is an actual height of the subject vehicle with a certain amount of margin added thereto. The predetermined period of time has been obtained as a period of time taken for determination in advance through experiments, etc. If an affirmative determination is made in step S211, there will be a high possibility that the subject vehicle will pass through the target, and hence, the routine advances to step S210, in which a determination is made that the target is not an obstacle. If a negative determination is made in step S211, the routine advances to step S212, in which a determination is made that the target is an obstacle.

Then, if a determination is made according to this routine that the target is an obstacle, the warning device 11 is operated. On the other hand, if the target is not an obstacle, the warning device 11 is not operated. Here, note that the sequence of the above-mentioned flow can be replaced or interchanged in an appropriate manner.

Thus, in this embodiment, even if the height of the target is not obtained in an accurate manner, it can be determined whether the target is an obstacle. Here, note that in this embodiment, it is determined based on the height of the target whether the target is an obstacle, a similar determination can be carried out even if an azimuth in a vertical direction of the target.

### Third Embodiment

In this third embodiment, obstacle determination processing is carried out in view of information on the surrounding environment of a subject (own) vehicle. The other devices, parts and so on are the same as those in the first embodiment, so the explanation thereof is omitted. Here, note that in this embodiment, a target to be detected is assumed to be a stationary object. The information on the surrounding environment of the subject vehicle can be detected by the use of a navigation system, for example. This navigation system is provided with a GPS device, so that the current position of the subject vehicle can be measured by means of the GPS device. Then, map information has been stored in advance in the navigation system, and the surrounding environment of the subject vehicle can be obtained by checking the current position of the vehicle with reference to the map information. When the surrounding environment of the subject vehicle obtained in this manner and the surrounding environment obtained by a radar are in match with each other, it can be said that the reliability of the information obtained by the radar is high.

Then, in this embodiment, the passing-through probability of the subject vehicle is calculated. The higher the probability that the subject vehicle can pass through the target, the larger becomes the passing-through probability of the subject vehicle. Then, if the passing-through probability of the subject vehicle is equal to or larger than a predetermined value, a determination is made that the target is not an obstacle.

FIG. 7 is a flow chart showing an obstacle determination flow or routine according to this third embodiment of the present invention. This routine is carried out by means of the ECU 10 in a repeated manner. Here, note that for those steps in which the same processing as in the above-mentioned flow is carried out, the same symbols are attached and an explanation thereof is omitted.

In step S301, it is determined according to the flow shown in FIG. 5 and FIG. 6 whether a determination has been made that the target is not an obstacle. That is, if a determination is made according to the flow described in the second embodiment that the target is not an obstacle, there will be a high possibility that the target is truly not an obstacle, and hence, the passing-through probability of the subject vehicle is made larger. If an affirmative determination is made in step S301, the routine advances to step S302, in which 1 is added to the passing-through probability of the target. On the other hand, if a negative determination is made in step S301, the routine advances to step S303, while leaving the passing-through probability of the target as it is.

In step S303, it is determined whether the height of the target is within a predetermined value. The predetermined value referred to herein can be set to an upper limit value of the height of the target over which the subject vehicle can pass through. That is, even if a thin iron plate or the like exists, the subject vehicle can pass through over the thin iron plate, the passing-through probability of the subject vehicle is made larger. If an affirmative determination is made in step S303, the routine advances to step S304, in which 1 is added to the passing-through probability of the target. On the other hand, if a negative determination is made in step S303, the routine advances to step S305, while leaving the passing-through probability of the target as it is.

In step S305, the information on the surrounding environment of the subject vehicle is obtained. The information on the surrounding environment can be obtained by means of the above-mentioned navigation system, a steering angle sensor that serves to detect the steering angle of a steering wheel of the subject vehicle, a yaw rate sensor that serves to detect the yaw rate of the subject vehicle, a vehicle speed sensor that serves to detect the speed of the subject vehicle, or the like. In addition, the information obtained by the receiving antenna part 4 is also contained in the information on the surrounding environment. For example, the surrounding environment is grasped based on coordinate information of a moving object such as a preceding vehicle or an oncoming vehicle.

In step S306, the passing-through probability of the subject vehicle is calculated in accordance with the surrounding environment obtained in step S305. For example, when the surrounding environment obtained by the navigation system and the surrounding environment obtained by the receiving antenna part 4 are in match with each other, the reliability of the radar is assumed to be high, so that the passing-through probability of the subject vehicle is made larger.

In step S307, it is determined whether a roadside object such as a guardrail exists. If a guardrail, etc., exists, radar waves will reflect on such a thing, so there will be a fear that it may become impossible to obtain the position of the target in an accurate manner. For this reason, if any roadside object does not exist, the reliability of the height of the target obtained is assumed to be high, and hence, the passing-through probability of the subject vehicle is made larger. If an affirmative determination is made in step S307, this routine is ended, while leaving the passing-through probability of the subject vehicle as it is. On the other hand, if a negative determination is made in step S307, the routine advances to step S308, in which 1 is added to the passing-through probability of the target, and thereafter, this routine is ended.

When the passing-through probability of the subject vehicle calculated in this manner is equal to or larger than the predetermined value, a determination is made that the target is not an obstacle, and the warning device 11 is not operated. On the other hand, when the passing-through probability of the subject vehicle calculated in this manner is less than the predetermined value, a determination is made that the target is an obstacle, and the warning device 11 is operated.

As described above, according to this embodiment, a determination as to whether the target is an obstacle is made by the use of the passing-through probability of the subject vehicle, so the accuracy of the determination can be enhanced to a further extent.

### EXPLANATION OF REFERENCE NUMERALS AND CHARACTERS

1 obstacle detection apparatus

2 oscillator

3 transmitting antenna

4 receiving antenna part

4a first receiving antenna

4b second receiving antenna

4c third receiving antenna

5 mixers

6 filters

7 ND converters

10 ECU

11 warning device

1. An obstacle detection apparatus characterized by comprising:
a receiving antenna part having a plurality of receiving antennas; and
determination means to determine a target is not an obstacle, if a rate of change in a reception intensity of reflected waves from said target received by said receiving antennas is within a predetermined range.

2. The obstacle detection apparatus as set forth in claim 1, characterized in that
said receiving antenna part has a plurality of combinations of the receiving antennas, of which the directions of arrangement are different from one another;
said determination means detects the target a plurality of times while changing the combination of said receiving antennas, makes a determination that said target is not an obstacle, if the rate of change in the reception intensity in each combination is within said predetermined range, and makes a determination that said target is an obstacle, if the rate of change in the reception intensity in at least one of the combinations is out of said predetermined range.

3. The obstacle detection apparatus as set forth in claim 2, characterized in that
said determination means detects the target by a combination of receiving antennas arranged in a horizontal direction, and a combination of receiving antennas arranged in an oblique direction or a vertical direction.

4. An obstacle detection apparatus characterized by comprising:
a receiving antenna part that has a combination of receiving antennas arranged in a horizontal direction, and a combination of receiving antennas arranged in an oblique direction or a vertical direction;
detection means that detects a lateral position in the horizontal direction of a target and a height of said target by means of the combinations of said receiving antennas; and
determination means that determines, from the rate of change in the height of the target obtained by said detection means, whether said target is an obstacle.

5. The obstacle detection apparatus as set forth in claim 4, characterized in that
said determination means makes a determination that said target is not an obstacle, if the rate of change in the height of said target is within a predetermined range.

6. The obstacle detection apparatus as set forth in claim 4 or 5, characterized in that
said determination means makes a determination that said target is not an obstacle, if a period of time in which the height of said target is equal to or larger than a predetermined height has continued for a predetermined period of time or more.

7. The obstacle detection apparatus as set forth in any one of claims 4 through 6, characterized in that
said determination means makes a determination that said target is not an obstacle, if the number of inflections of the rate of change in the height of said target is equal to or smaller than a predetermined value.

8. The obstacle detection apparatus as set forth in any one of claims 4 through 7, characterized in that
said determination means makes a determination that said target is not an obstacle, if a difference between a maximum value and a minimum value of the height of said target within a predetermined period of time is within a predetermined value.

9. The obstacle detection apparatus as set forth in any one of claims 4 through 8, characterized in that
said determination means makes a determination that said target is not an obstacle, if the height of said target has exhibited negative values, which indicate that the height of said target is lower than a road surface, for a predetermined period of time or more.
